(19) United States
(12) Patent Application Publication
(10) Pub. No.: US 2018/0186346 A1
(43) Pub. Date: Jul. 5, 2018

(54) Trailer Landing Gear Support Pad

(71) Applicant: Dumpster & Trailer Pads International, LLC, Hamden, CT (US)

(72) Inventor: Michael Tullo, Hamden, CT (US)

(21) Appl. No.: 15/851,876

(22) Filed: Dec. 22, 2017

Related U.S. Application Data
(60) Provisional application No. 62/437,908, filed on Dec. 22, 2016.

(51) Int. Cl. B60S 9/04

(52) U.S. Cl. CPC B60S 9/04

(57) ABSTRACT

A trailer landing gear support pad comprises a pair of plates and a block of support material configured to mount to the foot of a trailer landing gear. The landing gear foot has first and second toes received in respective first second slots defined by first and second plates. The first and second plates are secured to the block of support material, which extends from a bottom surface of the landing gear foot to the ground. One plate may include a pivoting arm spanning a slot, so the support pad may be secured to the landing gear foot by inserting one toe through a fixed slot, pivoting the support block to align the other slot, and closing the movable arm. The block of support material protects a concrete or asphalt ground surface from the weight of the trailer when the trailer is supported on jacks after removal of a tractor.

### BACKGROUND

This application relates to trailers towed behind cargo trucks, container shipping systems and heavy equipment that employs outriggers. Specifically, this application relates to an apparatus used to support and stabilize trailer landing gear or outriggers on a variety of surfaces.

Semi-trailer trucks comprising a tractor unit and a trailer are used to deliver the majority of goods sold in the United States and around the world. Containers from cargo ships are secured to a container trailer with wheels at the rear of the container and a hitch arranged at the front of the container. The container trailer allows the container to function as an over the road trailer. Each trailer includes a set of landing gear to support the front end of the trailer when the trailer is not connected to the tractor or a tow vehicle. The landing gear typically consists of a pair of mechanical jacks placed to either side of the hitch, as shown in FIG. A. Each jack has an extendable leg and includes a steel foot arranged to support the trailer on a surface where the trailer will be parked or stored. The foot at the bottom of each leg may be round, but are typically square or rectangular and have a size of about 10×10 inches, 8×10 inches or 12×12 inches. This size of the foot is configured to spread the weight of the trailer over a larger surface area and prevent the landing gear from sinking into the support surface.

A problem presented by the foot at the bottom of typical landing gear is that it may cause damage to the support surface below it and/or damage to the landing gear and trailer due to the direct contact between the foot and the support surface. This damage results in costs imposed on a user of the landing gear by the owner the land where the damage occurred and/or costs incurred by the user associated with repairing the landing gear and trailer.

Consequently, there is a need in the art for a support pad configured to securely affix to the landing gear assembly between the foot and the support surface to reduce damage to the support surface, the landing gear and the trailer.

### SUMMARY OF THE INVENTION

A trailer landing gear support pad (hereafter, “the support pad”) according to aspects of the disclosure includes a block of support material to be placed between a foot of a landing gear assembly and a support surface and means for securing the support pad to the foot of the landing gear. The support surface is typically asphalt or concrete. The block of support material protects the support surface from damage due to direct contact with the foot of the landing gear. The block of support material is also configured to spread the weight of a trailer over a greater surface area and prevent sinking of the landing gear into soft surfaces such as very hot asphalt or the like. The support pad will also provide a heat resistant barrier between the foot of the landing gear and the support surface.

In one embodiment, the support pad comprises a foot having a platform extending outward to a first toe and a second toe. The first and second toes extend from opposing sides of the foot. The first toe is received in a first slot defined by a first plate. The second toe is received in a second slot defined by a second plate. The first and second plates each define at least one opening and the at least one openings are arranged to align with each other beneath the platform to receive at least one fastener extending therethrough.

A block of support material is received between the plates and defines openings for the fasteners securing the plates to either side of the block of support material. The openings defined by the block of support material are configured to align with the fastener openings defined by the first plate and the second plate. In this arrangement, the fasteners pass through the opening defined by the first plate, the opening defined by the block of support material and the opening defined by the second plate to secure the first plate, the second plate and the block of support material together. In one embodiment, the slots are defined by the first and second plates are defined by one piece plates. In this embodiment, one plate must be removed or loosened relative to the block of support material to allow the trailer shoe to be mounted to the trailer landing support pad by inserting the fixed plate over one side of the foot, inserting the opposite side of the foot into the loosened plate, and then securing the loosened plate by tightening the fasteners.

A method of manufacturing the support pad comprises providing first and second plates and a block of support material. Each of the plates define a slot configured to receive the toe of a landing gear foot. The block of support material is configured to extend between the lower surface of the landing gear foot and a ground contact surface below a lower edge of the first and second plates. The block of support material includes openings for fasteners passing through the plates to secure the plates and block of support material together. The support pad is secured to the landing gear foot by inserting opposite sides (toes) of the landing gear foot through the slots in the first and second plates. At least one fastener inserts through the first plate, the block of support material and the second plate. Tightening the at least one fastener draws the first and second plates inward, compresses the block of support material between the plates, and secures the support pad to the landing gear foot.

In an alternative embodiment, one of the plates is comprised of a body portion and a movable arm, where the movable arm and the body portion define a slot that can be opened and closed by moving the arm from a closed position spanning the top of the slot to an open position. In the open position, the arm pivots to allow the toe of the landing gear foot to be received in the slot without removing or loosening the plate from the block of support material. The arm is secured in the closed position by fasteners such as a nut and bolt passing through both the plate and the arm. Other fastening arrangements such as a post and clip or pin may be used to secure the arm in the closed position. This embodiment permits mounting of the support pad to the landing gear foot without the need to separate or loosen one of the plates from the block of support material, simplifying installation.

The block of support material has an upper surface in contact with the bottom of the landing gear foot and a ground contact surface below the bottom edge of the plates. The block of support material may be constructed of rubber, recycled plastic, or other material that will protect the concrete or asphalt surface on which the trailer may be parked. The support material will be softer and more resilient than the steel of the landing gear foot. The slots in the plates and the openings for fasteners through the block of support material define the position of the upper surface of the block of support material relative to the bottom of the landing gear foot. In some embodiments, the upper surface of the block of support material is firmly in contact with the bottom of the landing gear foot when the support pad is installed on the landing gear. To ensure contact between the upper surface of the block of support material and the lower surface of the landing gear foot, at least a portion of the upper surface of the block of support material may extend above the slots defined by the first and second plates. In some embodiments, the block of support material may be a single, unitary block of material produced by molding. In this case, some raised features may be molded into the upper surface of the block of support material. In other embodiments, the block is built up from sheets of rubber or similar material. In the layered structure, one or more of the sheets of material may have a height greater than the other sheets, providing a raised portion of the upper surface of the block of support material. The raised portion of the upper surface comes into contact with the lower surface of the landing gear foot during installation and is maintained in contact when the fasteners or movable arm secure the support pad to the landing gear foot. The raised portions of the upper surface are slightly compressed during installation of the support pad, resulting in a mounted relationship that will not rattle and is less likely to loosen during use. Raised portions that are compressed during installation may help the support pad to be securely fitted to a variety of trailer landing gear by accommodating variation in the position and configuration of the bottom surface of the landing gear foot relative to the toes of the landing gear.

### BRIEF DESCRIPTION OF THE DRAWINGS

Aspects of a preferred embodiment will be described in reference to the drawings, wherein like numerals reflect like elements:

FIG. A shows a typical prior art trailer landing gear with a foot at the lower most point;

FIG. 1 is an exploded front perspective view of a representative trailer landing gear support pad (hereafter, “the support pad”) according to aspects of the disclosure;

FIG. 2 is a rear view of the support pad of FIG. 1, with a front view being identical;

FIG. 3 is a photograph showing a rear perspective view of a representative support pad according to aspects of the disclosure;

FIG. 4 is a photograph showing a side view of the support pad of FIG. 1;

FIG. 5 is a photograph showing a front perspective view of the support pad of FIG. 1;

FIG. 6 is a front perspective view of a second embodiment of a support pad according to aspects of the disclosure;

FIG. 7 is a photograph showing a right side exploded view from above of a third embodiment of a support pad according to aspects of the disclosure;

FIG. 8 is a photograph showing a right side view of the support pad of FIG. 5 with emphasis on a plate in an open state;

FIG. 9 is a photograph showing a left side view of the support pad of FIG. 5, and

FIG. 10 is a photograph showing a right side view of the support pad of FIG. 6 with emphasis on the plate in a closed state.

### DETAILED DESCRIPTION

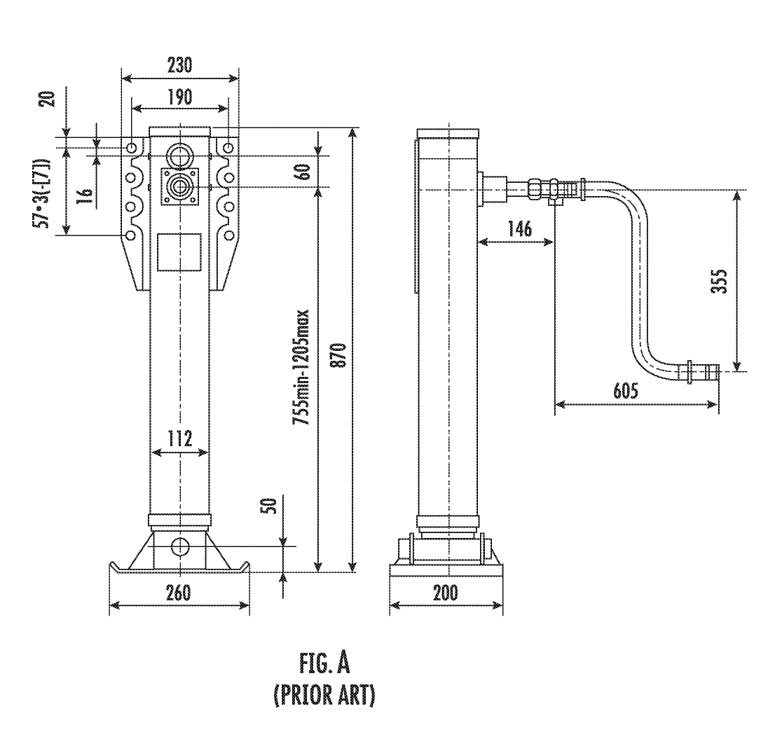

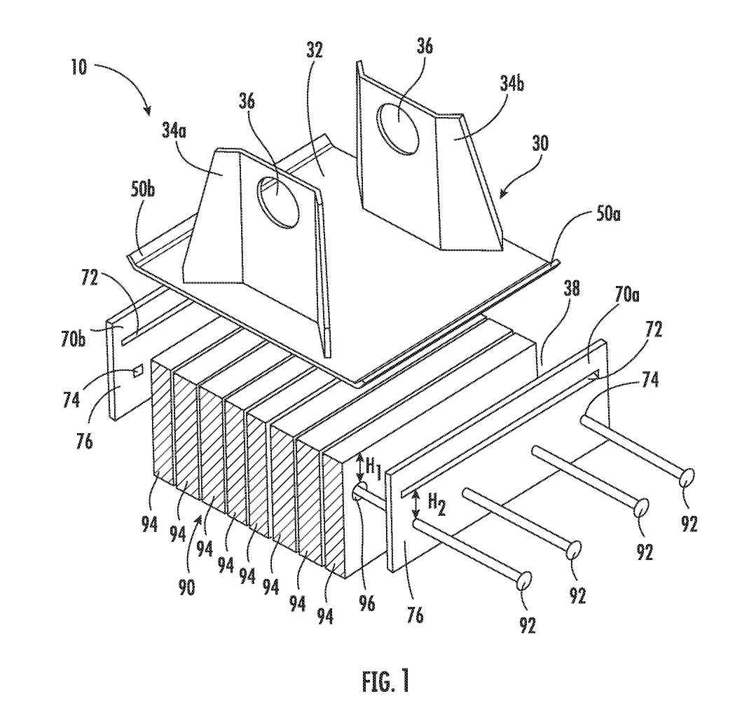

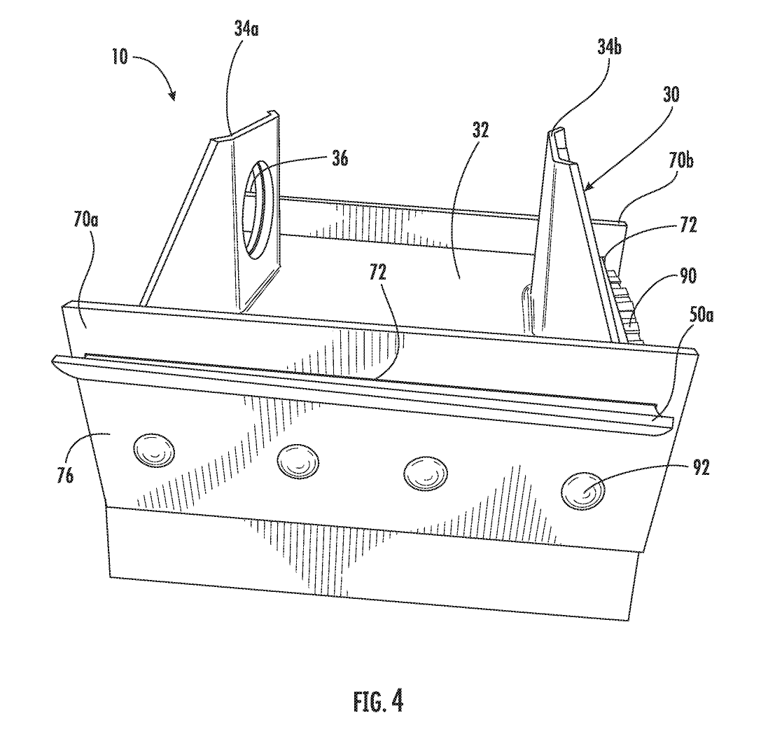

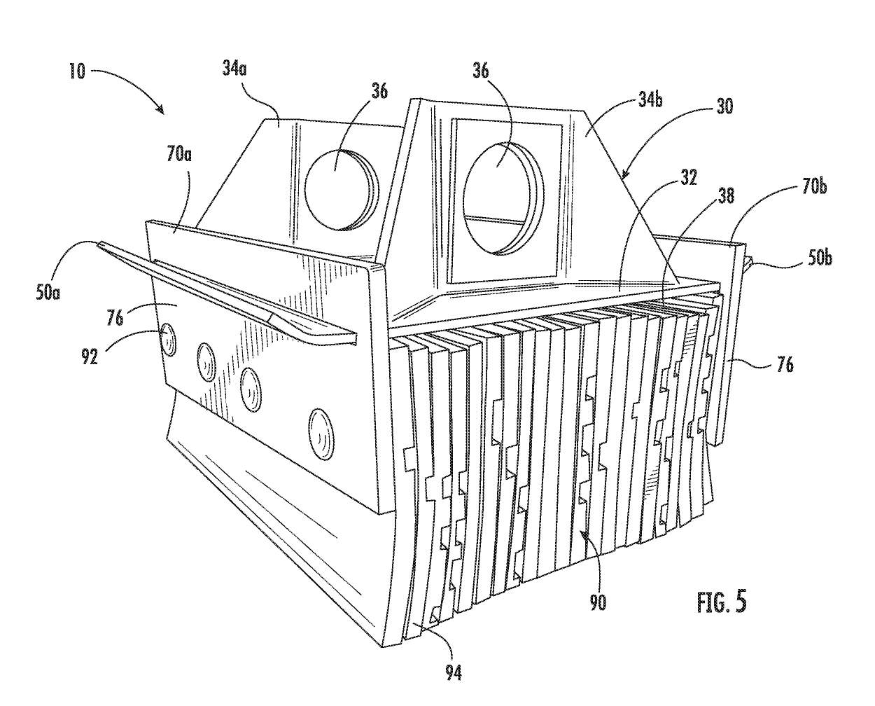

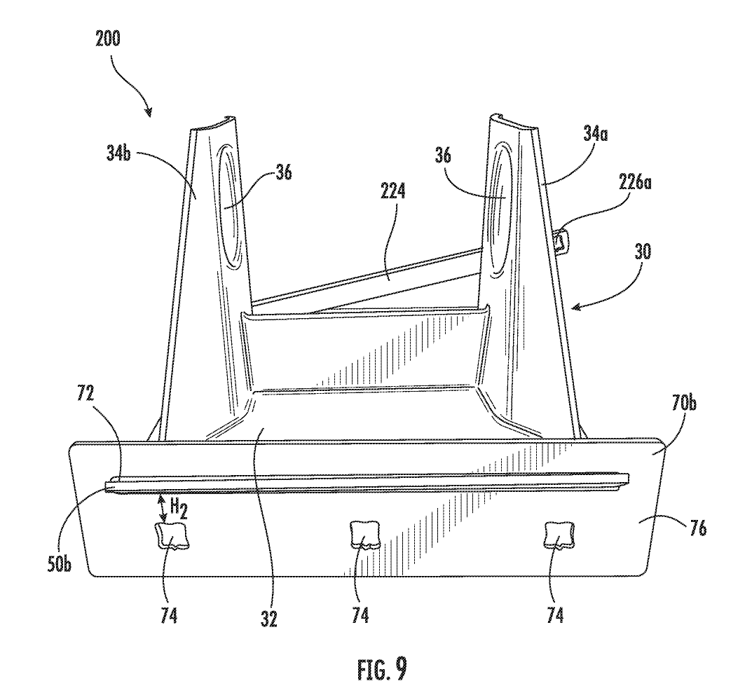

One embodiment of a trailer landing gear support pad (hereafter, “the support pad”) according to aspects of the disclosure will now be described with reference to FIGS. 1-10. The support pad will generally be referred to by the reference numeral 10. Various materials, methods of construction, methods of manufacture, and methods of fastening will be discussed in the context of the disclosed embodiment. Those skilled in the art will recognize known substitutes for the materials, manufacturing methods, and fastening methods, all of which are contemplated as compatible with the disclosed embodiment and are intended to be encompassed by the appended claims.

As shown in FIG. A, a prior art landing gear assembly for a trailer comprises two jack stands that are usually mounted with one jack stand to each side of a trailer hitch at a forward end of a trailer. At the bottom of each jack stand, a landing gear foot 30 has a lower surface that rests on a support surface such as concrete or asphalt to support the forward end of the trailer when the tractor has been dismounted from the trailer. The landing gear foot 30 is typically constructed of steel.

The disclosed support pad 10 is configured to cooperate with the foot 30 of the landing gear assembly of the trailer. The landing gear foot 30 has peripheral edges including a first (right) toe 50a on a first (right) side and a second (left) toe 50b on a second (left) side. Each toe 50a, 50b is comprised of a curved extension of a platform 32 of heavy gage steel that defines the lower surface of the foot 30. A first embodiment of the support pad 10 includes a first (right) plate 70a configured to mate with the right toe 50a, and a second (left) plate 70b configured to mate with the left toe 50b. A block of support material 90 is disposed between the right and left plates 70a, 70b. A plurality of fasteners 92 pass through the block of support material 90 to secure the right and left plates 70a, 70b, the block of support material 90 and the foot 30 to each other after the toes 50a, 50b are received in the slots 72 defined by the plates 70a, 70b, respectively. When the fasteners 92 are in place, the right and left plates 70a, 70b cannot be dislodged from the foot 30 of the landing gear, ensuring that the support pad 10 is securely attached to the landing gear foot 30.

As illustrated in FIGS. 1-5, the landing gear foot 30 includes a platform 32 with right and left toes 50a, 50b extending from the platform 32 on the right and left sides. Flanges 34a, 34b extend upward from the platform 32 between the right and left toes 50a, 50b. The flanges 34a, 34b couple the landing gear foot 30 to the jack as shown in FIG. A. Each toe 50a, 50b is comprised of an upwardly curved lip portion of the platform 32 that extends outwardly from the foot 30. Each toe 50a, 50b extends upwardly at an angle less than 90° to a height above the platform 32. Each flange 34a, 34b is oriented perpendicular to the toes 50a, 50b and defines annular opening 36. The annular openings 36 are aligned with each other to receive an axle to secure the jack leg to the foot 30 as shown in FIG. A.

In the support pad 10 of FIGS. 1-5, right and left plates 70a, 70b are each substantially rectangular and include substantially flat inner and outer surfaces. Each plate 70a, 70b is comprised of one integral component constructed of heavy gage steel, but a person having ordinary skill in the art would recognize that other materials strong enough to support a trailer may be compatible with the support pad 10. The right and left plates 70a, 70b each define an elongated slot 72 at an upper end for receiving respective right and left toes 50a, 50b of the platform 32 of the landing gear foot 30. The right and left plates 70a, 70b each include a body portion 76 at a lower end defining a series of fastener openings 74 for receiving the fasteners 92. Upon inserting the right and left toes 50a, 50b through each respective slot 72 in the right and left plates 70a, 70b, the plates 70a, 70b extend downward perpendicular to the platform 32 to a position beneath the platform 32. A block of support material 90 is positioned between the plates 70a, 70b and extends from the lower surface of the landing gear foot 30 to the ground. The block of support material 90 may be described as filling a region or void 38 defined between the right plate 70a and left plate 70b.

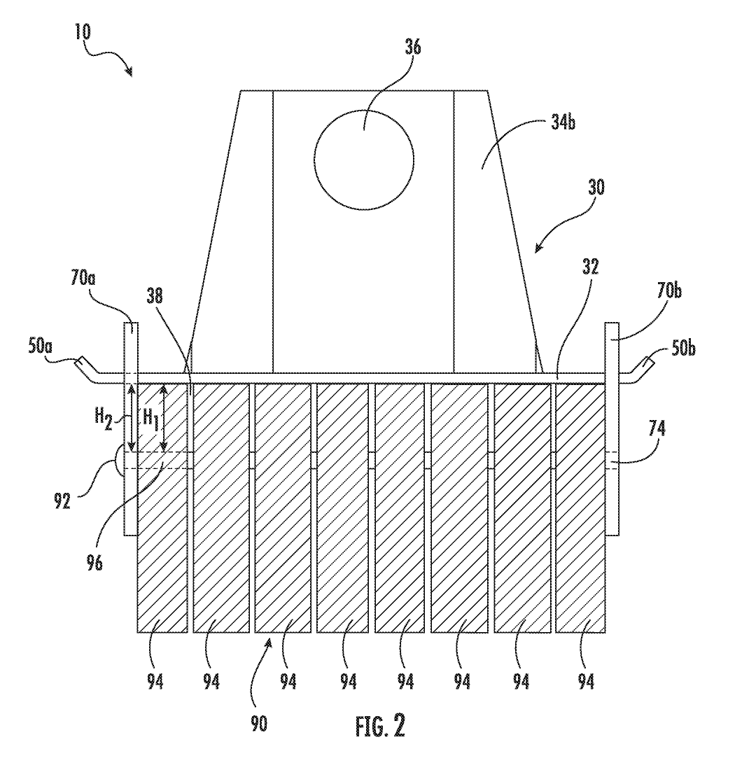

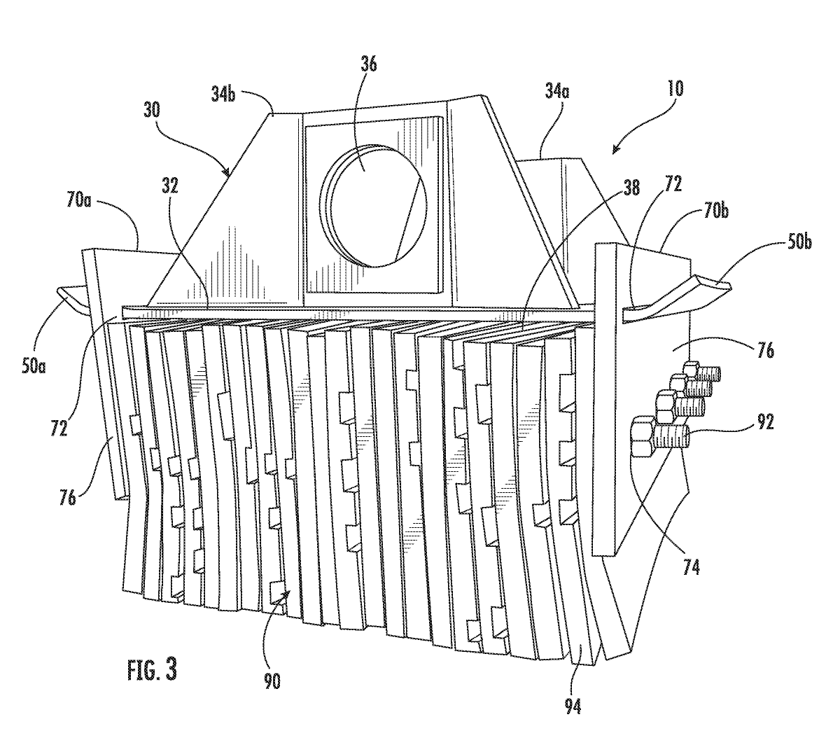

The density and composition of the block of support material 90 are selected to provide desired properties, such as chemical resistance, structural integrity, heat resistance, support and durability. As shown in FIGS. 1-3 of the first disclosed embodiment, the block of support material 90 is built up from layers of heavy rubber material, such as recycled rubber sheet 94, but other materials strong enough to support a trailer and soft enough not to damage asphalt or concrete may be compatible with the support pad 10. Each sheet 94 defines a series of fastener openings 96 that align with the openings 74 defined by the right and left plates 70a, 70b. The sheets 94 are sandwiched between the right and left plates 70a, 70b in a surface-to-surface relationship. The fasteners 92 pass through each sheet 94 and each plate 70a, 70b to secure the sheets 94 to each other. Tightening the fasteners 92 draws the plates 70a, 70b inward toward each other so that the toes 50a, 50b of the platform 32 project outwardly through the slots 72 and the sheets 94 are compressed between the plates 70a, 70b. The block of support material 90 is in contact with the lower surface of the platform 32 and extends below the lower edges of the plates 70a, 70b, so that the trailer is supported on the block of support material 90. The number of sheets 94 is selected to result in a block of support material 90 having a ground contact surface area at least as large as the lower surface of the platform 32. The length of each sheet 94 may be selected to provide additional surface area at the bottom of the disclosed support pad 10. The sheets 94 in the disclosed embodiment are generally rectangular, but may be trapezoid-shaped (longer at the bottom edge) to enlarge the footprint of the support pad 10 and spread the weight of the trailer over a larger area. The height of each sheet 94 will determine the height of the block of support material 90. As shown in FIGS. 2 and 3, in the disclosed embodiments it is preferred that the height of each sheet 94 is equal to or greater than the height of each plate 70a, 70b. It is preferred that a height H₁ (between the fastener opening 96 and the upper edge of the sheet 94) of at least one sheet 94 is equal to or greater than a height H₂ between each opening 74 and each respective slot 72 in the plates 70a, 70b. This results in a block of support material 90 in which each sheet 94 spans at least the entire height of each plate 70a, 70b. Having at least one sheet 94 with a height H₁ slightly exceeding height H₂ results in a configuration in which at least one sheet 94 or portion of the block of support material 90 exerts force against the lower surface of the platform 32 when both plates 70a, 70b are mated with each respective toe 50a, 50b. The force exerted by the at least one sheet 94 forms a tightly biased engagement between the plates 70a, 70b, the block of support material 90 and the landing gear foot 30. In this arrangement, the block of support material 90 acts as a natural spring biased upwardly against the lower surface of the platform 32. In the disclosed embodiments, the height of the support pad 10 corresponds to the dimension of the block of support material 90 beneath the landing gear foot 30. The height of the disclosed embodiments is between 4 and 6 inches, with a preferred height of about 4.5 to 5.5 inches. Adding height to the disclosed support pad 10 reduces the number of turns the mechanical jack for the landing gear must make to support the trailer and permit disconnection of the hitch.

The support pad 10 may alternatively be constructed of a solid block of support material or a block-shape of support material with internal support webs and an open structure to reduce weight.

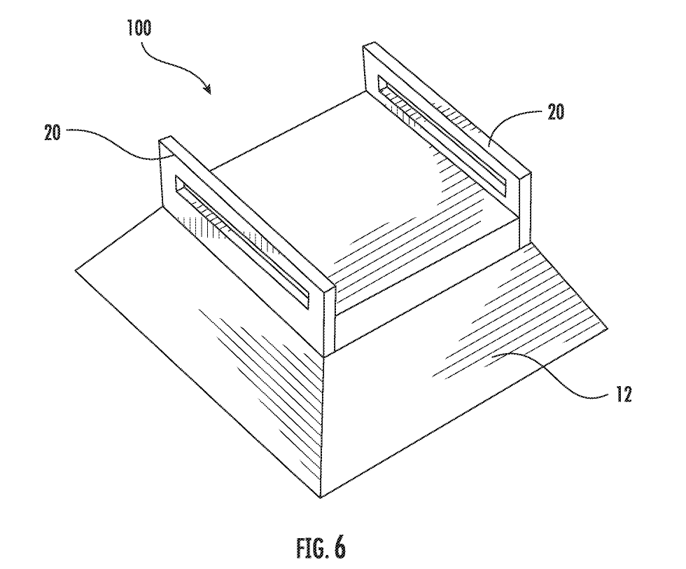

FIG. 6 illustrates a second embodiment of a support pad 100 according to aspects of the present disclosure. The support pad 100 is constructed of a pyramid shaped block of support material 12. A pair of heavy gauge metal mounting flanges 20 are embedded in the block of support material 12 and project upwardly to engage the toes 50a, 50b of the platform 32 of the landing gear foot 30. One or both of the mounting flanges 20 may be removably secured in the block of support material 12 by one or more fasteners. Other, less permanent means of securing the support pad 100 to the landing gear may be employed, such as straps, or a recess in the top of the support pad 100 that is configured to grip the edges of the leg of the landing gear. In the less permanently secured configurations, the support pad is installed during the process of lowering the landing gear (extending the jack stands), and is removed when the trailer is again hitched to a tractor.

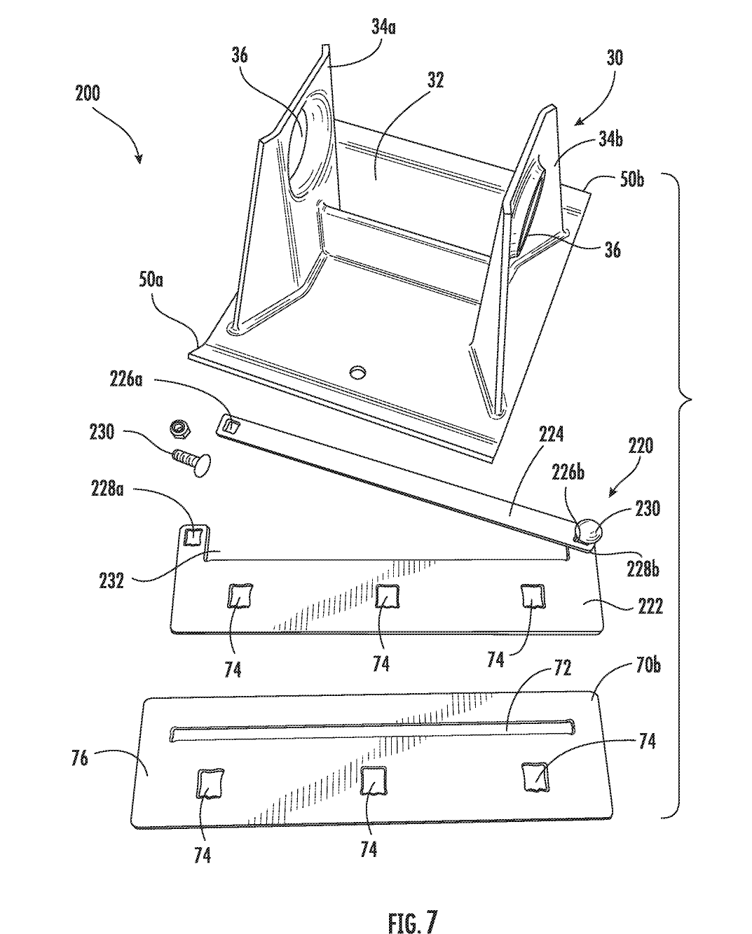

FIGS. 7-10 illustrate a third embodiment of a support pad 200. The support pad 200 is similar in structure and function to the first embodiment of the support pad 10, therefore like parts are assigned the same reference numerals. The support pad 200 differs from the support pad 10 in the configuration of the right plate 70a. The support pad 200 includes a first (left) plate 70b that is substantially identical to the right and left plates 70a, 70b of the first embodiment and a second (right) plate 220 having a body portion 222 defining openings 74 for receiving fasteners 92 and a movable arm 224. The arm 224 defines a first (front) attachment opening 226a and a second (rear) attachment opening 226b. The openings 226a, 226b defined by the arm 224 are configured to align with a first (front) attachment opening 228a and a second (rear) attachment opening 228b defined at an upper end of the body 222. When the front and rear openings 226a, 226b of the arm 224 and the front and rear openings 228a, 228b of the body 222 are aligned, first (front) and second (rear) fasteners 230 pass through front openings 226a, 228a and rear openings 226b, 228b of the arm 224 and the body 222 to affix the arm 224 to the body 222 and define an elongated slot 232 for receiving the right toe 50a. As described above with respect to the first embodiment, the height H₁ (between the fastener opening 96 and the upper edge of the sheet 94) of at least one sheet 94 is equal to or greater than a height H₃ between each opening 74 and slot 232 defined by the right plate 220 to ensure contact between the upper surface of the block of support material 90 and a lower surface of the platform 32 of the landing gear foot 30.

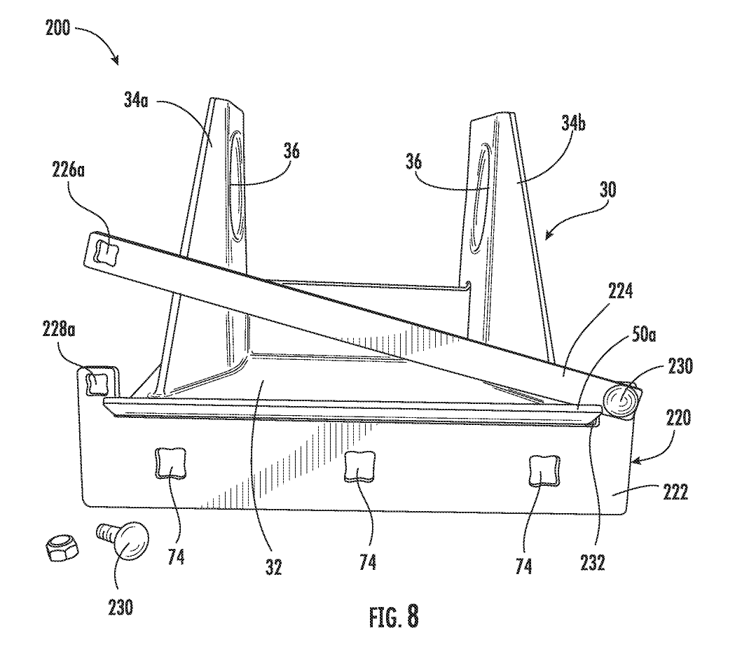

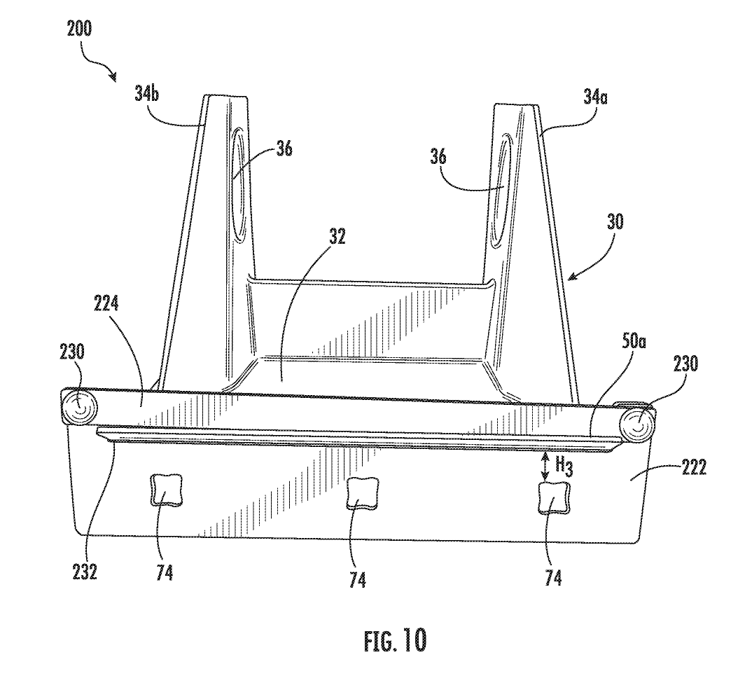

As shown in FIG. 8, having only one fastener 230 inserted through either the aligned front openings 226a, 228a or the aligned rear openings 226b, 228b allows the right plate 220 to have a hinged relationship between the arm 224 and the body 222. In the hinged relationship, the arm 224 is capable of rotating about the fastener 230, acting as a pivot and/or bearing, so that the right plate 220 is capable of transitioning between an open state and a closed state (shown in FIG. 10). An alternative configuration may employ a permanently secured pivot at one end of the arm 224 and a removable fastener at the opposite end. In the open state, shown in FIG. 8, the arm 224 is pivoted upward and the unaligned front opening 226a is positioned above front opening 228a. In the closed position, shown in FIG. 10, the arm 224 is pivoted downward and the previously unaligned front opening 226a of the arm 224 is aligned with the front opening 228a of the body 222. In the closed position, the front fastener 230 can be inserted through the front openings 226a, 228a so that the right plate 220 is capable of securely affixing to the foot 30 and functioning similarly to the right and left plates 70a, 70b of the first embodiment. In the closed position, the movable arm 224 defines the upper side of the slot 232.

In the embodiment of FIGS. 7-10, fasteners 92 pass through openings 74 in plates 220, 70b to secure the plates 220, 70b to the block of support material 90 (not shown in FIGS. 7-10). Fasteners 92 are inserted through openings 74 and 96 to draw the right and left plates 220, 70b inwardly along the platform 32 and compress the block of support material 90. The embodiment of FIGS. 7-10 does not require loosening or removal of any of the fasteners 92 during installation as is required in the embodiment of FIGS. 1-5. To install the embodiment of FIGS. 7-10, the left toe 50b is inserted through the slot 72 defined by the left plate 70b. The support pad 200 is then pivoted to position the right toe 50a in the open slot 232. The movable arm 224 is positioned above the right toe 50a and is rotated downward to align the front openings 226a, 228a and secure the right toe 50a between the arm 224 and the body 222. Force may be necessary on the arm 224 in the downward direction to align the front openings 226a, 228a because, as mentioned above, the height H₁ between each opening 96 and the upper edge of at least one sheet 94 is equal to or greater than the height H₃ between each opening 74 and the slot 232. Therefore, any raised portion of the block of support material 90 must be compressed to latch the arm 224 to the body 222. When aligned, a fastener 230 is inserted through front openings 226a, 228a so that slot 232 is fully defined by the right plate 220 around the right toe 50a.

While a preferred embodiment of the disclosed trailer landing gear support pad 10, 100, 200 has been set forth for purposes of illustration, the foregoing description should not be deemed a limitation of the invention. Accordingly, various modifications, adaptations and alternatives may occur to one skilled in the art without departing from the spirit of the disclosure and the scope of the claimed coverage.

What is claimed:

1. A support pad for cooperating with trailer landing gear including a foot having a platform extending outward to a first toe and a second toe, said first and second toes extending from opposing sides of the foot, said support pad comprising:
a first plate defining a first slot and a second plate defining a second slot, said first toe received in the first slot and said second toe received in the second slot, said first and second plates each defining at least one opening capable of aligning with each other beneath the platform for receiving at least one fastener;
a block of support material defining at least one opening, the at least one opening defined by the block of support material aligning with the at least one opening defined by the first plate and the second plate, and
wherein, the at least one fastener passes through the at least one opening defined by the first plate, the at least one opening defined by the block of support material and the at least one opening defined by the second plate to secure the the first plate, the second plate and the block of support material together with the first and second toes of the landing gear foot in the first and second slots.

2. The support pad of claim 1, wherein the block of support material is in contact with a lower surface of the platform.

3. The support pad of claim 1, wherein the block of support material is comprised of a plurality of rubber sheets sandwiched between the right and left plates in a surface-to-surface relationship.

4. The support pad of claim 1, wherein the block of support material is comprised of a plurality of sheets and the height of at least one sheet is greater than the height of the first and second plates.

5. The support pad of claim 1, wherein the height of the block of support material is equal to or greater than the height of the first and second plates.

6. The support pad of claim 1, wherein the second plate is capable of transitioning between an open state and a closed state.

7. The support pad of claim 1, wherein the second plate is comprised of a body portion and a movable arm and said movable arm affixes to the body to span the second slot.

8. The support pad of claim 1, wherein the second plate is comprised of a body portion and an arm pivoting between an open position allowing removal of said support pad from the foot of the landing gear and a closed position securing said support pad to the foot of the landing gear.

9. The support pad of claim 1, wherein the block of support material is comprised of a plurality of sheets and at least one sheet has a height H₁ between the at least one opening and an upper edge greater than a height H₂ between the at least one opening of each plate and each respective slot.

10. A support pad for cooperating with trailer landing gear including a foot having a platform extending outward to a first toe and a second toe, said first and second toes extending from opposing sides of the foot, said support pad comprising:
a first plate defining a first slot and at least one opening and a second plate defining a second slot and at least one opening aligned with the at least one opening of the first plate;
a block of support material disposed between the first and second plates defining at least one opening aligned with the at least one opening of the first and second plates;
at least one fastener extending through the aligned openings defined by the first plate, the second plate and the block of support material, and
wherein, said first toe is received in said first slot and said second toe is received in said second slot to secure the support pad to the landing gear.

11. The support pad of claim 10, wherein the second plate is comprised of a body and a movable arm capable of transitioning between an open state and a closed state defining the second slot, said support pad mating with the landing gear when said arm is in a closed state.

12. The support pad of claim 11, wherein the second plate is comprised of a body and a movable arm capable of pivoting between an open state and a closed state and pivoting the arm to the open state allows for removal of the support pad from the landing gear.

13. The support pad of claim 10, wherein a height H₁ between the at least one opening of the block of support material and an upper edge of the block of support material is greater than a height H₂ between the at least one opening of each plate and each slot.

14. A method of manufacturing a support pad for cooperating with trailer landing gear comprising a foot having a platform extending outward to a first toe and a second toe, said first and second toes extending from opposing sides of the foot, said method of manufacturing comprising:
mating a first plate with the first toe, said first plate extending downward to a position beneath the platform;
positioning a block of support material beneath the platform between the first and second toes;
mating a second plate with the second toe, said second plate extending downward to a position beneath the platform, and
inserting at least one fastener through the first plate, the block of support material and the second plate.

15. The method of manufacturing a support pad of claim 14, wherein the step of mating a first plate includes the first plate defining an elongated slot for receiving the first toe.

16. The method of manufacturing a support pad of claim 14 comprising the step of defining a void between the first plate, the second plate and the platform.

17. The method of manufacturing a support pad of claim 14 comprising the step of tightening the at least one fastener to draw the first and second plates inward to compress the block of support material.
